(19) United States
(12) Patent Application Publication
(10) Pub. No.: US 2026/0124721 A1
(43) Pub. Date: May 7, 2026

(54) POWER RATCHET WRENCH HEAD

(71) Applicant: HSU HUAN CHIANG, TAICHUNG CITY (TW)

(72) Inventor: HSU HUAN CHIANG, TAICHUNG CITY (TW)

(21) Appl. No.: 19/237,124

(22) Filed: Jun. 13, 2025

(30) Foreign Application Priority Data
Nov. 7, 2024 (TW) 113142680

(51) Int. Cl. B25B 21/00; B25F 5/00

(52) U.S. Cl. CPC B25B 21/004; B25F 5/001

(57) ABSTRACT

A power ratchet wrench head has an outer casing, a gear set, a crank set, and a ratchet set. The outer casing has a closed end, an open end, a chamber, and a fixing portion. The gear set is connected to the outer casing and has a fixing sleeve, a gear sleeve, and a planetary gear seat. The fixing sleeve has a front locking portion and a rear locking portion. The front locking portion is formed on the fixing sleeve and is connected to the fixing portion. The rear locking portion is formed on the fixing sleeve and is spaced apart from the front locking portion. The crank set is disposed in the outer casing, is connected to the gear set, and has a crankshaft. The ratchet set is connected to the outer casing and the crank set and has a ratchet yoke, a transmission shaft, and a control knob.

### BACKGROUND OF THE INVENTION

### 1. Field of the Invention

The present invention relates to a power tool, and more particularly to a power ratchet wrench head that can improve structural strength, can improve transmission stability, and can extend the service life.

### 2. Description of Related Art

A conventional power ratchet wrench is driven by eccentric swinging, so as to rotate components such as bolts or nuts in a forward or reverse direction to fasten or loosen the components. The conventional power ratchet wrench has a body, a driving device, and a wrench head. The body is for a user to hold and is connected to a power source. The driving device is connected to the body and has a cylinder and a rotor. The power source is flowed into the driving device via the body to drive the rotor to rotate relative to the cylinder. The wrench head is connected to the driving device and has a gear set, a crank set, and a ratchet set. The gear set is connected to the driving device to enhance the torque. The crank set is connected to the gear set to perform yaw rotation. The ratchet set is connected to the crank set to rotate the component in a forward or reverse direction to fasten or loosen.

Although the torque of the conventional power ratchet wrench can be enhanced by eccentric swinging and the transmission of the gear set, in order to facilitate the assembly of the ratchet set, the wrench head of the conventional power ratchet wrench is configured with an open outer casing having an upper clamping panel and a lower clamping panel, and the ratchet set is clamped by the two clamping panels. However, after the conventional power ratchet wrench is used for a long time, the two clamping panels are easily twisted and deformed due to the yaw vibration between the crank set and the ratchet set due to the insufficient structural strength of the two clamping panels. The ratchet set may be relatively offset relative to the crank set, thereby affecting the transmission of the crank set to the ratchet set and generating noise, and the offset of the crank set and the ratchet set will also increase the shaking, thereby causing the two clamping panels to be damaged or broken.

In addition, for mitigating the problem caused by the insufficient structural strength of the two clamping panels of the above-mentioned outer casing, currently, the outer casing of the crank set is set to a closed sleeve structure type to improve the structural strength of the outer casing. Though the closed sleeve structure type of the outer casing can increase the structural strength of the outer casing and avoid damage or breakage caused by insufficient structural strength, the outer casing of the sleeve structure type is provided with an annular flange at the rear end, and is connected to the body by a connecting ring engaged with the annular flange. Since the outer casing and the body are positioned and connected only by the engagement of the annular flange and the connecting ring, the vibration generated during the use of the conventional power ratchet wrench can easily cause the connecting ring and the outer casing to shake, causing the connecting ring and the outer casing to loosen, resulting in an offset between the ratchet set and the gear set disposed in the outer casing, which will still affect the transmission of the crank set to the ratchet set and generate noise. The offset between the crank set and the ratchet set will increase the shaking, and further damage the casing. The damaged conventional power ratchet wrench cannot be used anymore, which will increase the cost of use and affect its service life. In summary, the conventional power ratchet wrench needs to be improved.

To overcome the shortcomings, the present invention tends to provide a power ratchet wrench head to mitigate the aforementioned problems.

### SUMMARY OF THE INVENTION

The main objective of the invention is to provide a power ratchet wrench head that may provide a buffering effect and extend the service life.

A power ratchet wrench head in accordance with the present invention has an outer casing, a gear set, a crank set, and a ratchet set. The outer casing has a closed end, an open end, a chamber, and a fixing portion. The gear set is connected to the outer casing and has a fixing sleeve, a gear sleeve, and a planetary gear seat. The fixing sleeve has a front locking portion and a rear locking portion. The front locking portion is formed on the fixing sleeve adjacent to a front end of the fixing sleeve and is connected to the fixing portion. The rear locking portion is formed on the fixing sleeve adjacent to a rear end of the fixing sleeve and is spaced apart from the front locking portion. The gear sleeve has a threaded portion. The crank set is disposed in the outer casing, is connected to the gear set, and has a crankshaft. The ratchet set is connected to the outer casing and the crank set and has a ratchet yoke, a transmission shaft, and a control knob.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a power ratchet wrench head in accordance with the present invention;

FIG. 2 is an exploded perspective view of the power ratchet wrench head in FIG. 1;

FIG. 3 is another exploded perspective view of the power ratchet wrench head in FIG. 1;

FIG. 4 is a side view in partial section of the power ratchet wrench head in FIG. 1; and

FIG. 5 is an operational side view in partial section of the power ratchet wrench head in FIG. 1.

### DETAILED DESCRIPTION OF PREFERRED EMBODIMENTS

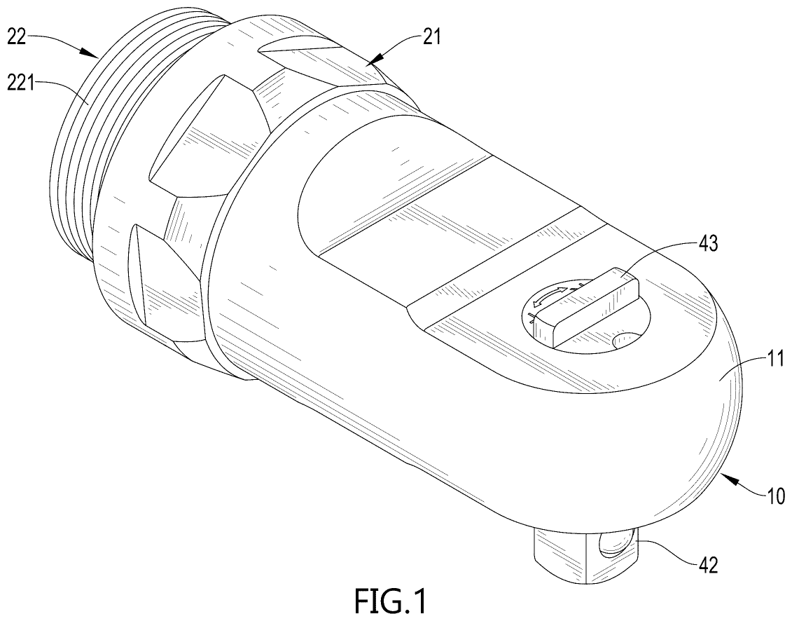

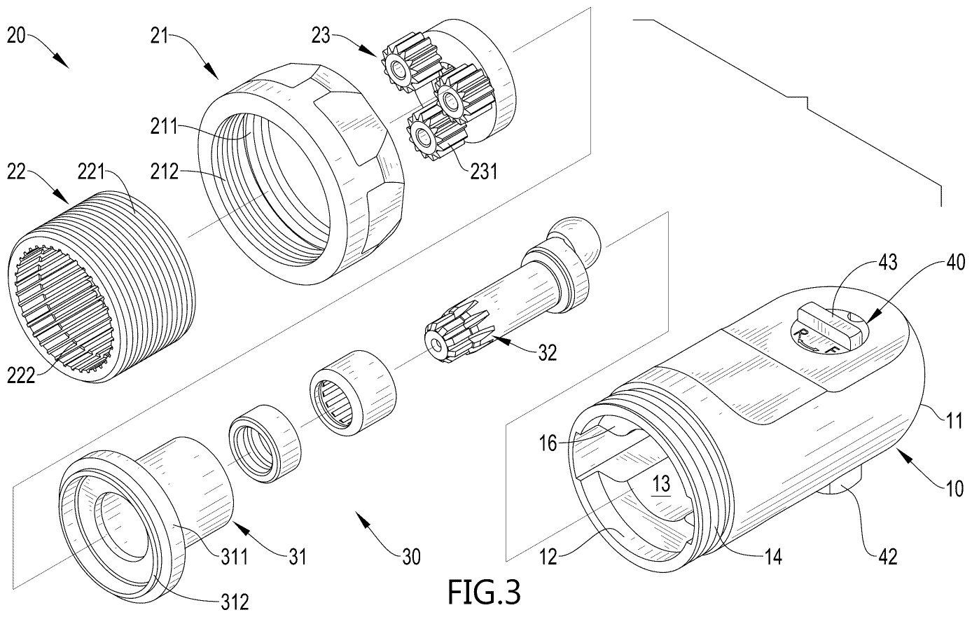

With reference to FIGS. 1 to 4, a power ratchet wrench head in accordance with the present invention comprises an outer casing 10, a gear set 20, a crank set 30, and a ratchet set 40.

The outer casing 10 is a closed sleeve structure and has a closed end 11, an open end 12, a chamber 13, a fixing portion 14, an assembly hole 15, and an assembly recess 16. The closed end 11 and the open end 12 are respectively disposed on two ends of the outer casing 10. The chamber 13 is formed in the outer casing 10 between the closed end 11 and the open end 12. The fixing portion 14 is formed on an external surface of the outer casing 10 and is disposed at the open end 12. The assembly hole 15 is formed through a top side and a bottom side of the outer casing 10 adjacent to the closed end 11 and communicates with the chamber 13. The assembly recess 16 is formed in the outer casing 10, is disposed at the open end 12, and communicates with the chamber 13.

The gear set 20 is connected to the outer casing 10 and has a fixing sleeve 21, a gear sleeve 22, and a planetary gear seat 23. The fixing sleeve 21 is connected to the outer casing 10 and has a front locking portion 211 and a rear locking portion 212. The front locking portion 211 is formed on an inner surface of the fixing sleeve 21 adjacent to a front end of the fixing sleeve 21 and is connected to the fixing portion 14 of the outer casing 10. The rear locking portion 212 is formed on the inner surface of the fixing sleeve 21 adjacent to a rear end of the fixing sleeve 21 and is spaced apart from the front locking portion 211. Preferably, each one of the front locking portion 211 and the rear locking portion 212 is an inner thread, and spiral directions of the inner threads of the rear locking portion 212 and the front locking portion 211 are opposite to each other.

The gear sleeve 22 is connected to the fixing sleeve 21 and has a threaded portion 221 and multiple engaging teeth 222. The threaded portion 221 is formed on an external surface of the gear sleeve 22, and a front end of the gear sleeve 22 is connected to the rear locking portion 212 of the fixing sleeve 21 via the threaded portion 221, such that the gear sleeve 22 is spaced apart from the open end 12 of the outer casing 10. A rear end of the gear sleeve 22 is connected to a body of a power ratchet wrench via the threaded portion 221. The engaging teeth 222 are formed on an inner surface of the gear sleeve 22. The planetary gear seat 23 is disposed in the gear sleeve 22 and has multiple planetary gears 231. The planetary gears 231 are disposed on a side of the planetary gear seat 23 and engage with the engaging teeth 222 of the gear sleeve 22.

The crank set 30 is disposed in the outer casing 10, is connected to the gear set 20, and has a positioning mount 31 and a crankshaft 32. The positioning mount 31 is disposed in the chamber 13 via the open end 12 of the outer casing 10 and abuts against the gear sleeve 22 to hold the positioning mount 31 between the outer casing 10 and the gear sleeve 22. In addition, the positioning mount 31 has an abutting ring 311 and a connecting ring 312. The abutting ring 311 is radially formed on and protrudes from a rear end of the positioning mount 31, is disposed in the assembly recess 16 of the outer casing 10, and abuts against the front end of the gear sleeve 22. The connecting ring 312 is axially formed on and protrudes from a side of the abutting ring 311 facing the gear sleeve 22, and extends into the gear sleeve 22. The crankshaft 32 is connected to the positioning mount 31 and has a rear end and a front end. The rear end of the crankshaft 32 extends out of the positioning mount 31 and engages with the planetary gears 231 of the planetary gear seat 23. The front end of the crankshaft 32 extends out of the positioning mount 31 and extends into the chamber 13 of the outer casing 10.

The ratchet set 40 is connected to the outer casing 10 and the crank set 30 and has a ratchet yoke 41, a transmission shaft 42, and a control knob 43. The ratchet yoke 41 is swingably disposed in the chamber 13 of the outer casing 10 and abuts against the front end of the crankshaft 32. The transmission shaft 42 is connected to the assembly hole 15 of the outer casing 10 and engages with the ratchet yoke 41. The control knob 43 is connected to the transmission shaft 42 to rotate the transmission shaft 42 relative to the ratchet yoke 41.

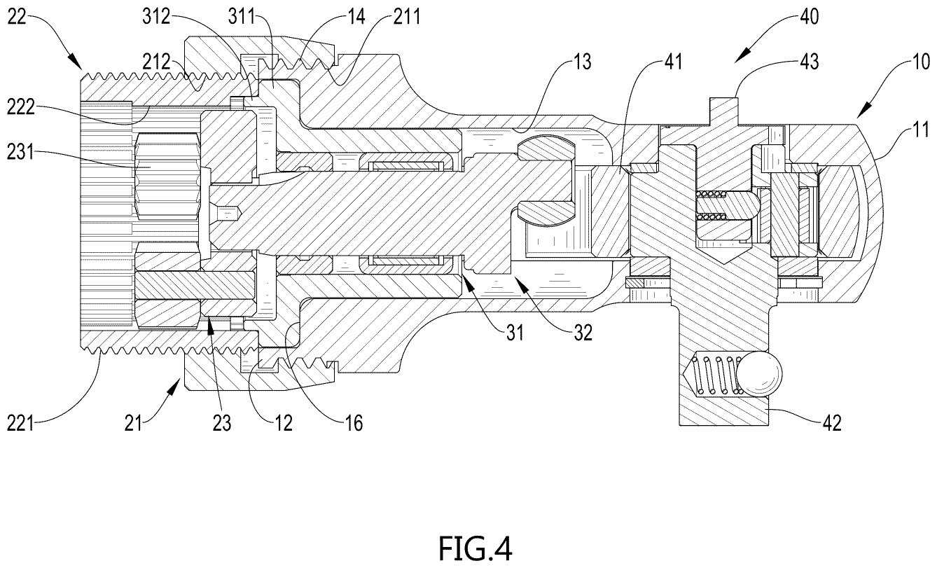

With reference to FIGS. 1 and 4, when the power ratchet wrench head of the present invention is in use, since the crank set 30 and the ratchet set 40 are arranged in the closed sleeve structure of the outer casing 10 for vibration, the outer casing 10 has sufficient structural strength to avoid deformation or damage caused by vibration, ensures that there is no offset between the crank set 30 and the ratchet set 40 located in the outer casing 10, and can stably and accurately transmit power to the gear set 20 without generating noise. In addition, it can also avoid the situation where there is increased shaking due to offset, effectively avoiding damaging the outer casing 10, greatly improving the structural strength of the power ratchet wrench head of the present invention, improving the stability of operation, and extending the service life.

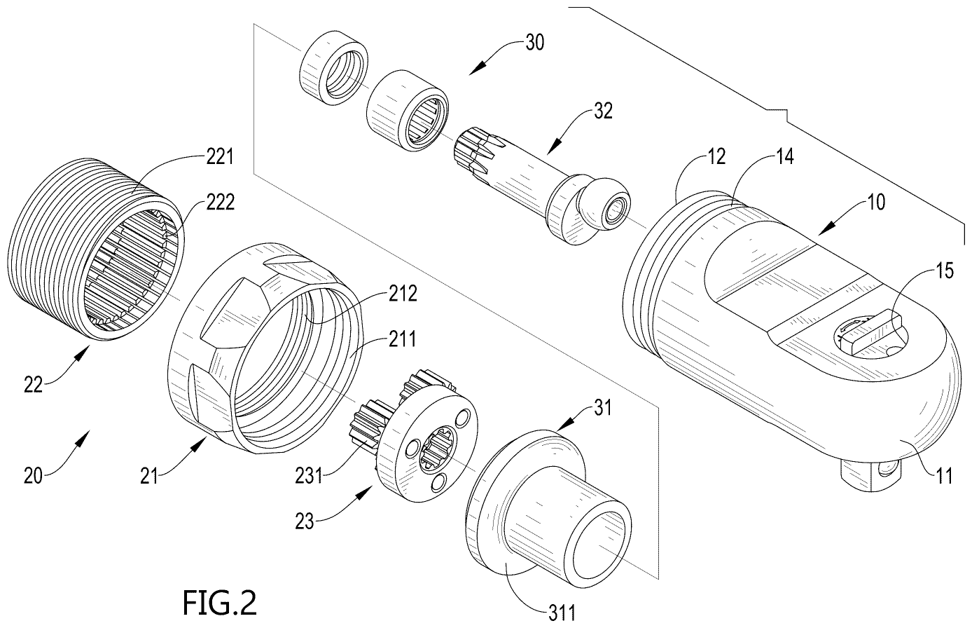

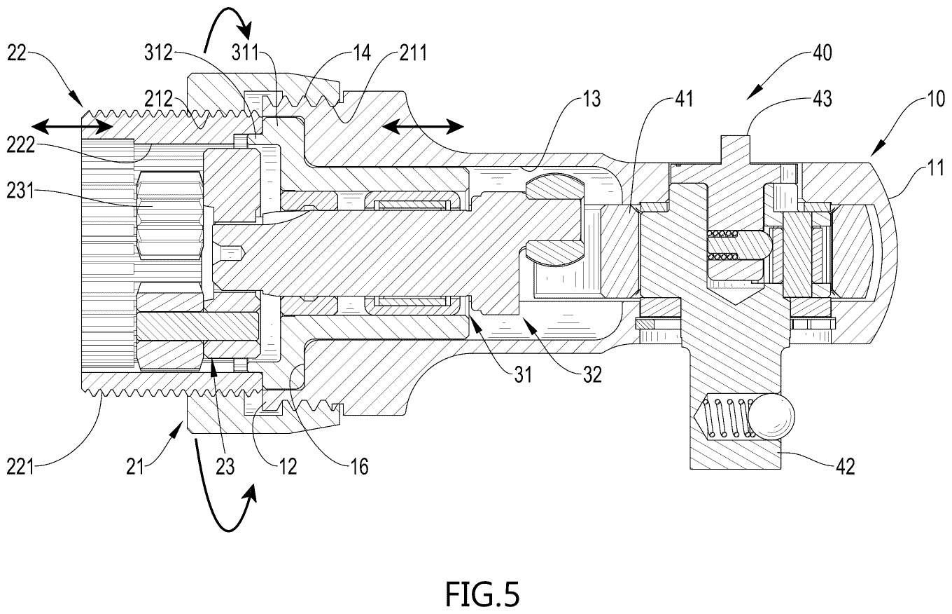

Furthermore, with reference to FIGS. 2, 3, and 5, when assembling the power ratchet wrench head of the present invention, the fixing portion 14 is provided on the outer casing 10, and the fixing sleeve 21 is provided with the front locking portion 211 and the rear locking portion 212 spaced from each other. Since the spiral directions of the inner threads of the front locking portion 211 and the rear locking portion 212 are oppositely arranged, the user only needs to rotate the fixing sleeve 21 to simultaneously lock and connect the outer casing 10 and the gear sleeve 22 through the front locking portion 211 and rear locking portion 212. That is, the crank set 30 is positioned between the outer casing 10 and the gear set 20 by approaching each other. In addition, during disassembly, the outer casing 10 and the gear sleeve 22 can be moved away from each other by rotating the fixing sleeve 21. Therefore, the power ratchet wrench head of the present invention is provided with the front locking portion 211 and the rear locking portion 212 respectively locked with and connected to the fixing portion 14 of the outer casing 10 and the threaded portion 221 of the gear sleeve 22 by the fixing sleeve 21, so as to provide a stable connecting structural strength, effectively improving the conventional power ratchet wrench head which is only connected by a clamping method during use, and is easy to cause the connecting ring and the outer casing to shake and loosen due to vibration, resulting in relative deviation, affecting the transmission of the crank set to the ratchet set and generating noise, and increasing the shaking due to the deviation of the crank set and the ratchet set. Therefore, the present invention provides a power ratchet wrench head that can improve structural strength, can improve transmission stability, and can extend the service life.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

WHAT IS CLAIMED IS:

1. A power ratchet wrench head comprising:
an outer casing having
a closed end;
an open end;
a chamber formed in the outer casing between the closed end and the open end; and
a fixing portion formed on an external surface of the outer casing and disposed at the open end;
a gear set connected to the outer casing and having
a fixing sleeve connected to the outer casing and having
a front locking portion formed on an inner surface of the fixing sleeve adjacent to a front end of the fixing sleeve and connected to the fixing portion of the outer casing; and
a rear locking portion formed on the inner surface of the fixing sleeve adjacent to a rear end of the fixing sleeve and spaced apart from the front locking portion;
a gear sleeve connected to the fixing sleeve and having
a threaded portion formed on an external surface of the gear sleeve; and
a front end of the gear sleeve connected to the rear locking portion of the fixing sleeve via the threaded portion; and
a planetary gear seat disposed in the gear sleeve and engaging with the gear sleeve;
a crank set disposed in the outer casing, connected to the gear set, and having
a crankshaft having
a rear end engaging with the planetary gear seat; and
a front end extended into the chamber of the outer casing; and
a ratchet set connected to the outer casing and the crank set and having
a ratchet yoke swingably disposed in the chamber of the outer casing and abutting against the front end of the crankshaft;
a transmission shaft connected to the outer casing and engaging with the ratchet yoke; and
a control knob connected to the transmission shaft to rotate the transmission shaft relative to the ratchet yoke.

2. The power ratchet wrench head as claimed in claim 1, wherein
each one of the front locking portion and the rear locking portion is an inner thread; and
spiral directions of the inner threads of the rear locking portion and the front locking portion are opposite to each other.

3. The power ratchet wrench head as claimed in claim 2, wherein the crank set has a positioning mount disposed in the chamber via the open end of the outer casing and abutting against the gear sleeve to hold the positioning mount between the outer casing and the gear sleeve.

4. The power ratchet wrench head as claimed in claim 3, wherein
the outer casing has an assembly recess formed in the outer casing, disposed at the open end of the outer casing, and communicating with the chamber; and
the positioning mount has an abutting ring radially formed on and protruded from a rear end of the positioning mount, disposed in the assembly recess of the outer casing, and abutted against the front end of the gear sleeve.

5. The power ratchet wrench head as claimed in claim 4, wherein the positioning mount has a connecting ring axially formed on and protruded from a side of the abutting ring facing the gear sleeve, and extended into the gear sleeve.

6. The power ratchet wrench head as claimed in claim 1, wherein
the outer casing has an assembly hole formed through a top side and a bottom side of the outer casing adjacent to the closed end and communicating with the chamber; and
the transmission shaft is connected to the assembly hole of the outer casing.

7. The power ratchet wrench head as claimed in claim 2, wherein
the outer casing has an assembly hole formed through a top side and a bottom side of the outer casing adjacent to the closed end and communicating with the chamber; and
the transmission shaft is connected to the assembly hole of the outer casing.

8. The power ratchet wrench head as claimed in claim 3, wherein
the outer casing has an assembly hole formed through a top side and a bottom side of the outer casing adjacent to the closed end and communicating with the chamber; and
the transmission shaft is connected to the assembly hole of the outer casing.

9. The power ratchet wrench head as claimed in claim 4, wherein
the outer casing has an assembly hole formed through a top side and a bottom side of the outer casing adjacent to the closed end and communicating with the chamber; and
the transmission shaft is connected to the assembly hole of the outer casing.

10. The power ratchet wrench head as claimed in claim 5, wherein
the outer casing has an assembly hole formed through a top side and a bottom side of the outer casing adjacent to the closed end and communicating with the chamber; and
the transmission shaft is connected to the assembly hole of the outer casing.

11. The power ratchet wrench head as claimed in claim 6, wherein
the gear sleeve has multiple engaging teeth formed on an inner surface of the gear sleeve; and
the planetary gear seat has multiple planetary gears disposed on a side of the planetary gear seat and engaging with the engaging teeth of the gear sleeve.

12. The power ratchet wrench head as claimed in claim 7, wherein
the gear sleeve has multiple engaging teeth formed on an inner surface of the gear sleeve; and
the planetary gear seat has multiple planetary gears disposed on a side of the planetary gear seat and engaging with the engaging teeth of the gear sleeve.

13. The power ratchet wrench head as claimed in claim 8, wherein
the gear sleeve has multiple engaging teeth formed on an inner surface of the gear sleeve; and
the planetary gear seat has multiple planetary gears disposed on a side of the planetary gear seat and engaging with the engaging teeth of the gear sleeve.

14. The power ratchet wrench head as claimed in claim 9, wherein
the gear sleeve has multiple engaging teeth formed on an inner surface of the gear sleeve; and
the planetary gear seat has multiple planetary gears disposed on a side of the planetary gear seat and engaging with the engaging teeth of the gear sleeve.

15. The power ratchet wrench head as claimed in claim 10, wherein
the gear sleeve has multiple engaging teeth formed on an inner surface of the gear sleeve; and
the planetary gear seat has multiple planetary gears disposed on a side of the planetary gear seat and engaging with the engaging teeth of the gear sleeve.

16. The power ratchet wrench head as claimed in claim 1, wherein
the gear sleeve has multiple engaging teeth formed on an inner surface of the gear sleeve; and
the planetary gear seat has multiple planetary gears disposed on a side of the planetary gear seat and engaging with the engaging teeth of the gear sleeve.

17. The power ratchet wrench head as claimed in claim 2, wherein
the gear sleeve has multiple engaging teeth formed on an inner surface of the gear sleeve; and
the planetary gear seat has multiple planetary gears disposed on a side of the planetary gear seat and engaging with the engaging teeth of the gear sleeve.

18. The power ratchet wrench head as claimed in claim 3, wherein
the gear sleeve has multiple engaging teeth formed on an inner surface of the gear sleeve; and
the planetary gear seat has multiple planetary gears disposed on a side of the planetary gear seat and engaging with the engaging teeth of the gear sleeve.

19. The power ratchet wrench head as claimed in claim 1, wherein the crank set has a positioning mount disposed in the chamber via the open end of the outer casing and abutting against the gear sleeve to hold the positioning mount between the outer casing and the gear sleeve.

20. The power ratchet wrench head as claimed in claim 19, wherein
the outer casing has an assembly recess formed in the outer casing, disposed at the open end of the outer casing, and communicating with the chamber; and
the positioning mount has
an abutting ring radially formed on and protruded from a rear end of the positioning mount, disposed in the assembly recess of the outer casing, and abutted against the front end of the gear sleeve; and
a connecting ring axially formed on and protruded from a side of the abutting ring facing the gear sleeve, and extended into the gear sleeve.
